(19) United States
(12) Patent Application Publication
(10) Pub. No.: US 2003/0222924 A1
(43) Pub. Date: Dec. 4, 2003

(54) Method and system for browsing a virtual environment

(76) Inventor: John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 10/163,205

(22) Filed: Jun. 4, 2002

(51) Int. Cl. G09G 5/00

(52) U.S. Cl. 345/850

(57) ABSTRACT

A method and system for browsing a virtual environment provides the user simultaneously with both a standard and a rear or side view of the virtual environment. The invention facilitates locating items of interest in a wide variety of virtual reality applications.

### FIELD OF THE INVENTION

The present invention relates generally to virtual reality systems and more specifically to methods for browsing a virtual environment.

### BACKGROUND OF THE INVENTION

Recent advances in computer hardware and software have made possible powerful virtual reality systems applicable to a wide variety of applications. A virtual reality system may be loosely defined as a simulated, three-dimension, computer-graphics-generated environment with which a user may interact in real time. Some virtual reality systems employ tactile or other feedback to create a heightened sense of realism.

One application for virtual reality systems is the browsing of large quantities of data. For example, a virtual warehouse floor might contain stacks of inventoried items, or a virtual library might contain shelves full of books. In such applications, a user may typically turn in all directions to view objects of interest. However, if a user forgets to look in all directions, items of interest may be missed. It is thus apparent that there is a need in the art for an improved method for browsing a virtual environment.

### SUMMARY OF THE INVENTION

A method for browsing a simulated three-dimensional virtual environment is provided. A display system for carrying out the method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of a display system in accordance with an illustrative embodiment of the invention.

FIGS. 2A-2E are illustrations showing various ways in which a display may be divided into a first region containing a first view of a virtual environment and a second region containing a second view of the virtual environment in accordance with an illustrative embodiment of the invention.

FIGS. 3A and 3B are illustrations of a simple virtual environment in accordance with an illustrative embodiment of the invention.

FIGS. 4A and 4B are illustrations showing ways in which a user may interact with sub-regions of a second view of a virtual environment in accordance with an illustrative embodiment of the invention.

FIG. 5 is a flowchart of the operation of the display system shown in FIG. 1 in accordance with an illustrative embodiment of the invention.

### DETAILED DESCRIPTION OF THE INVENTION

Browsing a virtual environment is facilitated by providing the user with two different views of the virtual environment simultaneously: a first or primary view to the front and a second view to the rear or side. The concept is similar to a virtual rearview mirror but with some important enhancements, which will be explained in this description.

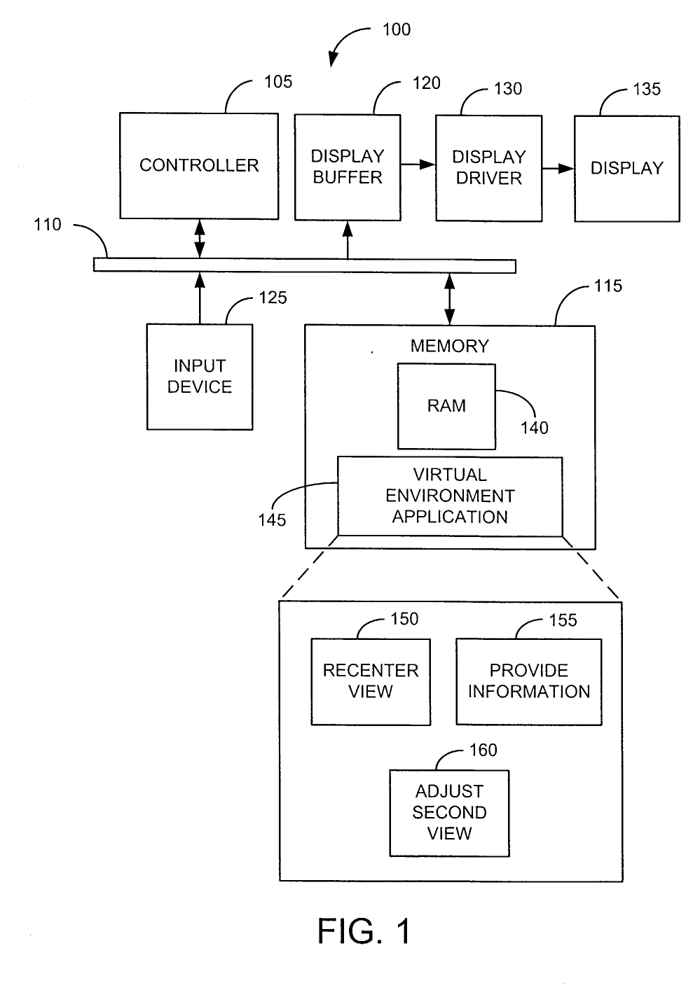

FIG. 1 is a functional block diagram of a display system in accordance with an illustrative embodiment of the invention. In FIG. 1, controller 105 communicates via data bus 110 with memory 115, display buffer 120, and input device 125. Display buffer 120 outputs image data to display driver 130, which controls display 135. Memory 115 comprises random access memory (RAM) 140, a portion of which may be allocated to virtual environment application 145. Virtual environment application 145 further comprises Modules 150, 155, and 160. Module “Recenter View” (150) changes the first view on display 135 to coincide with a selected sub-region in the second view. Module “Provide Information” (155) provides information about a selected sub-region of the second view. Module “Adjust Second View” (160) adjusts the magnification factor or viewing angle of the second view.

Controller 105 may be a general purpose microprocessor or a dedicated graphics accelerator. Input device 125 may be any device capable of indicating a particular location on display 135 and issuing command requests. Examples include a mouse, trackball, digital tablet, or eye-movement-detection interface. A command request may be issued by the pressing of a button on input device 125 or other suitable gesture.

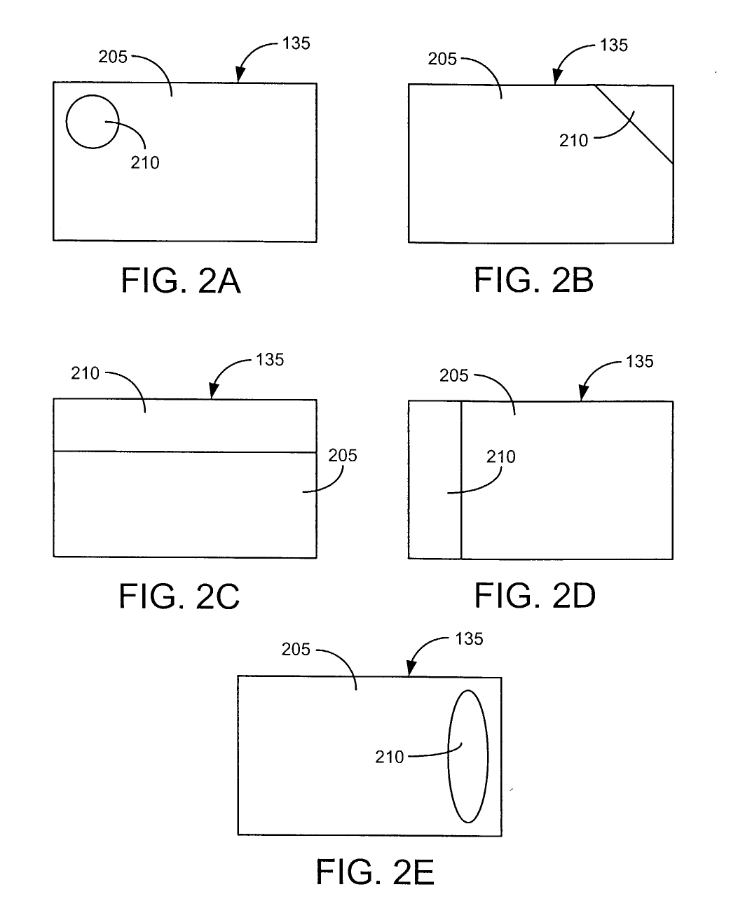

FIGS. 2A-2E illustrate various ways in which display 135 may be divided into a first region containing a first view of a virtual environment and a second region containing a second view of the virtual environment in accordance with an illustrative embodiment of the invention. In FIGS. 2A-2E, display 135 is divided into first region 205 and second region 210. First region 205 contains a first (e.g., front) view of the virtual environment. Second region 210 contains a second view of the virtual environment substantially opposite in direction of the first view or to the side with respect to the first view. FIGS. 2A-2E illustrate that second region 210 may vary in shape, size, position, and orientation. The configurations shown are only examples, however; many other configurations are possible. In some embodiments, the user may dynamically select from among various sizes, shapes, positions, and orientations for second region 210 to fit a particular situation.

The viewing angle and magnification factor of the second view shown within second region 210 may also be adjusted. For example, in a PC implementation, input device 125 is typically a two-button mouse. Right clicking within second region 210 may invoke Module “Adjust Second View” (160), causing a user interface control to appear for setting the viewing angle and magnification factor of the second view. These features provide the user with greater flexibility in finding objects or information of interest in the virtual environment.

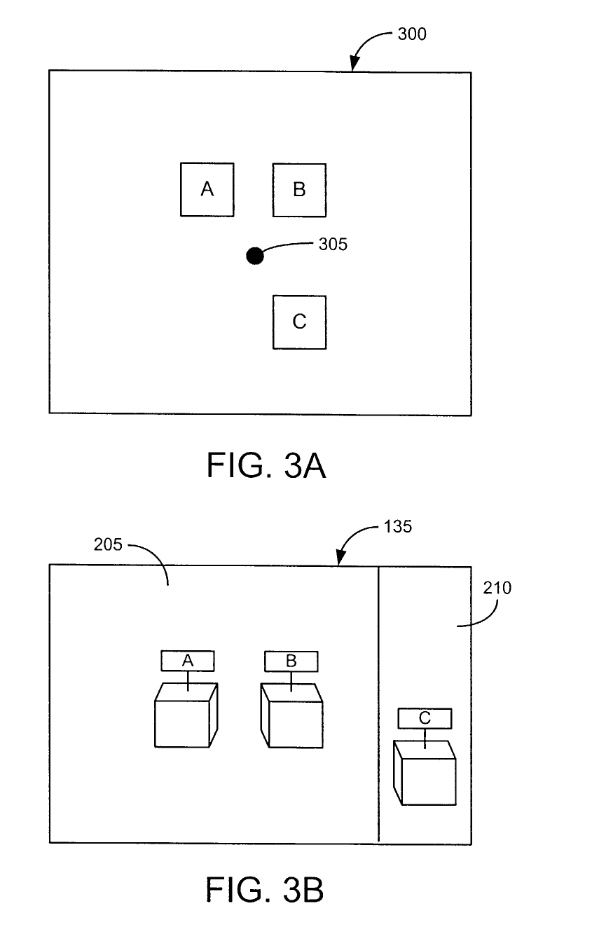

FIGS. 3A and 3B are illustrations of a simple virtual environment in accordance with an illustrative embodiment of the invention. FIG. 3A is a top view of a virtual environment 300 containing cubic objects A, B, and C. A perspective rendering of virtual environment 300 from the point of view of an observer at point 305 is shown in FIG. 3B. In FIG. 3B, Objects A and B are visible in the first view within first region 205. Object C, although behind the observer, is visible in the second view within second region 210. In this example, the angle of view for the second view is toward the rear with respect to the first view. Although, in this example, the second view in second region 210 is similar to a virtual rearview mirror, the text label “C” is shown in readable form instead of mirror imaged, as would occur in a model of a true reflection. This is an important distinction between the illustrative embodiment in FIG. 3B and the virtual rearview mirror included in some racing car simulators, for example. Virtual environments often include “signs” containing text such as those pictured in FIG. 3B. Being able to read such text is advantageous to a user attempting to browse a virtual environment.

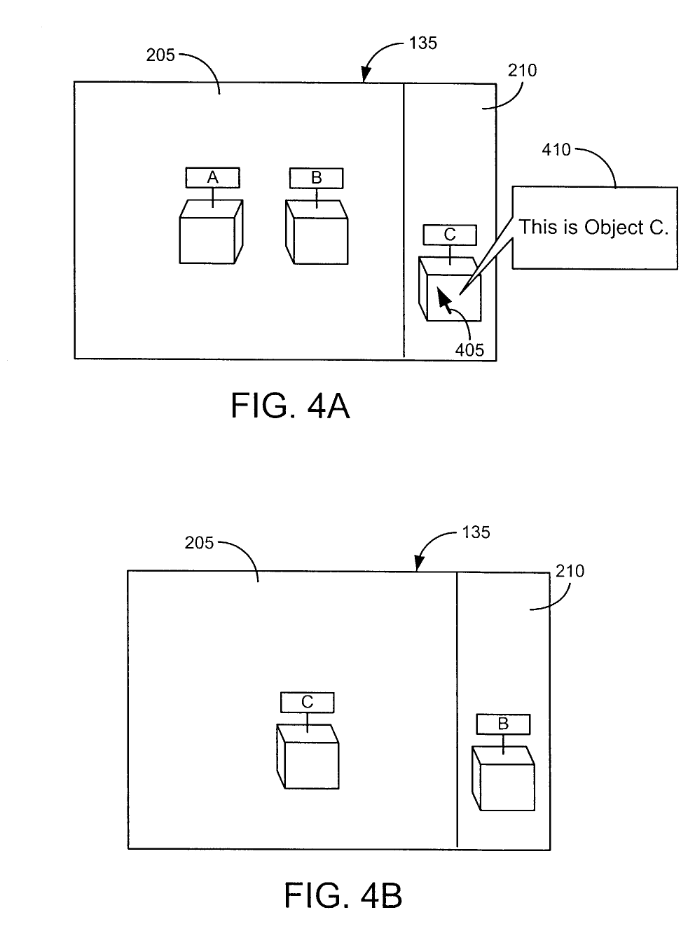

FIGS. 4A and 4B illustrate ways in which a user may interact with sub-regions of the second view of virtual environment 300 in accordance with an illustrative embodiment of the invention. In FIG. 4A, a pointing cursor 405 associated with input device 125 hovers over Object C in the second view of virtual environment 300. The hovering gesture may invoke Module “Provide Information” (155), causing callout 410 to appear. Callout 410 may contain a description or other information regarding Object C. If the user takes the further step of issuing a command request (e.g., selecting Object C), Module “Recenter View” (150) may be invoked, causing the first view shown within first region 205 to be recentered on Object C and the second view to be updated accordingly, as shown in FIG. 4B. In this example, the viewing angle, magnification factor, or both of the second view may be adjusted to display both Objects A and B within the second view, as explained above.

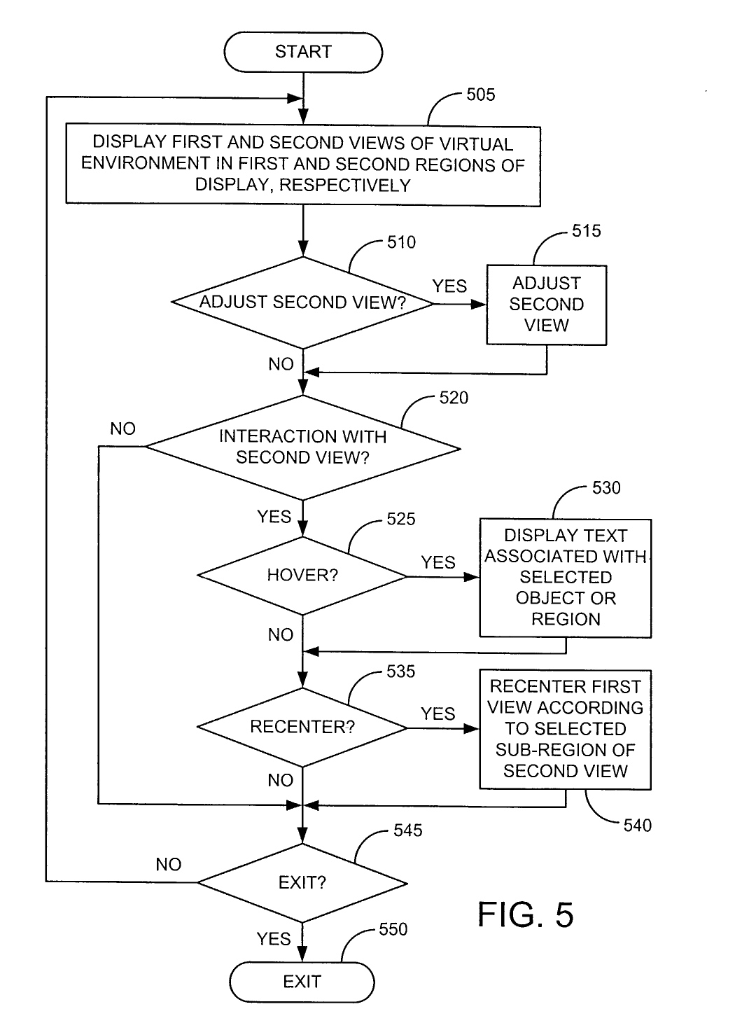

FIG. 5 is a flowchart of the operation of the display system shown in FIG. 1 in accordance with an illustrative embodiment of the invention. FIG. 5 summarizes the concepts discussed in connection with FIGS. 2-4. At 505, first and second views of virtual environment 300 are displayed within first region 205 and second region 210, respectively, of display 135. If a request is received at 510 to adjust the size, shape, position, or orientation of second region 210, Module “Adjust Second View” (160) is activated to perform the adjustment at 515. Otherwise, control proceeds to 520. If an interaction with the second view is detected at 520, control proceeds to 525. Otherwise, control skips to 545. Input such as a pointer cursor hovering over a sub-region of the second view at 525 may invoke Module “Provide Information” (155) to provide a text message about the indicated sub-region at 530. In other embodiments, the information provided at 530 may be audio instead of text. If a command request from input device 125 is detected at 535, control proceeds to 540, where Module “Recenter View” (150) is invoked to recenter the first view within first region 205 to coincide with the selected sub-region of the second view, and the second view is updated accordingly. If a request to exit virtual environment 300 is received at 545, the process terminates at 550. Otherwise, control returns to 505.

Applications for the present invention are numerous and diverse. The invention may be applied advantageously, for example, to distance learning; virtual libraries, museums, and shops; recreation and entertainment such as video games; 3-D chat rooms; military and corporate training; and the browsing of databases, including those containing only text.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for browsing a simulated three-dimensional virtual environment on a display, the virtual environment comprising at least one object, the method comprising:
displaying, in a first region of the display, a first view of the virtual environment; and
displaying simultaneously, in a second region of the display, a second view of the virtual environment, the second region being adjustable in at least one of size, shape, position, and orientation, the second view being adjustable in at least one of viewing angle and magnification factor, objects having associated text being shown in the second view with the text in readable form.

2. The method of claim 1, wherein the second view depicts the virtual environment as seen from a direction substantially opposite that of the first view.

3. The method of claim 1, further comprising:
changing the first view of the virtual environment to coincide with a particular sub-region within the second view in response to an input.

4. The method of claim 1, further comprising:
providing information about a particular sub-region within the second view in response to an input.

5. The method of claim 4, wherein the information comprises text.

6. The method of claim 4, wherein the information comprises audio.

7. A display system for viewing a simulated three-dimensional virtual environment comprising at least one object, the display system comprising:
control logic configured to generate a first view and a second view of the virtual environment;
a display having a first region and a second region, the first region displaying the first view, the second region displaying the second view, the second region being adjustable in at least one of size, shape, position, and orientation, the second view being adjustable in at least one of viewing angle and magnification factor, objects having associated text being shown in the second view with the text in readable form; and
an input device to interact with the virtual environment.

8. The display system of claim 7, wherein the second view depicts the virtual environment as seen from a direction substantially opposite that of the first view.

9. The display system of claim 7, wherein the input device is configured to select a particular sub-region within the second view.

10. The display system of claim 9, wherein the control logic is configured to center the first view of the virtual environment on the particular sub-region in response to the selection of the particular sub-region.

11. The display system of claim 9, wherein the control logic is configured to provide information about the particular sub-region in response to the selection of the particular sub-region.

12. A display system for viewing a simulated three-dimensional virtual environment comprising at least one object, the display system comprising:
logic means for generating a first view and a second view of the virtual environment;
display means having a first region and a second region, the first region displaying the first view, the second region displaying the second view, the second region being adjustable in at least one of size, shape, position, and orientation, the second view being adjustable in at least one of viewing angle and magnification factor, objects having associated text being shown in the second view with the text in readable form; and
input means for interacting with the virtual environment.

13. The display system of claim 12, wherein the second view depicts the virtual environment as seen from a direction substantially opposite that of the first view.

14. The display system of claim 12, wherein the input means is configured to select a particular sub-region within the second view.

15. The display system of claim 14, wherein the logic means is configured to center the first view of the virtual environment on the particular sub-region in response to the selection of the particular sub-region.

16. The display system of claim 14, wherein the logic means is configured to provide information about the particular sub-region in response to the selection of the particular sub-region.
